(19) United States
(12) Patent Application Publication
(10) Pub. No.: US 2004/0243463 A1
(43) Pub. Date: Dec. 2, 2004

(54) Publicity planning pack

(76) Inventor: Tom Wells, Whiddon Down (GB)

Correspondence Address: PEARNE & GORDON LLP, 1801 EAST 9TH STREET, SUITE 1200, CLEVELAND, OH, 44114-3108, US

(21) Appl. No.: 10/447,089

(22) Filed: May 28, 2003

(51) Int. Cl. G06F 17/60; A63F 1/00; A63F 9/20

(52) U.S. Cl. 705/14; 273/292

(57) ABSTRACT

The publicity planning pack is a process for aiding individuals or groups in implementing a publicity plan for an organization. The publicity planning pack includes a deck of playing cards to facilitate the process and make it fun and interesting, while also focusing the participants toward the development of one or more publicity plans.

This application relates generally to a method for generating ideas for publicity planning, and more specifically, to a “game-like” process for aiding participants to think about and utilize existing publicity channels more diversely, more effectively and more economically.

### BACKGROUND OF THE INVENTION

Publicity (or Public Relations, or PR) can be important to modern organizations, such as businesses, to get their messages out to the public and to make the public (and, in particular, for commercial enterprise—consumers) aware of the organization and its activities. Often, organizations will hire specialized entities or individuals (such as consultants) to develop publicity channels and implement public relations for the organization. However, the organization's own staff (employees, members, and/or volunteers, for example) are often underutilized for this particular task, and thus represent a potential resource to be tapped.

The organization's staff are often intimately aware of the activities, services, and/or products of the organization. Further, the staff are also likely to have a variety of personal interests and experiences that could be useful in developing a varied and comprehensive publicity strategy. Consequently, it would be useful for an organization to have a process (i.e., method) for utilizing staff skills and experiences to aid in developing an organization's publicity and public relations approaches.

Generally speaking, publicity works by matching an organization's communications wants and needs (what they want to say, who they want to say it to) with those of various media outlets (how they want to say it). Organizations typically want to communicate a particular set of messages to particular groups of people. Further, the organization needs to determine what communications channels can be economically utilized. In addition, the various media actively seek information, news stories and other material which will appeal to their readers, listeners or viewers. When properly matched together, organizations can economically receive publicity and PR by utilizing various media, that—unlike advertising—the organization does not have to pay much for, and can obtain much more economically.

As a result, publicity and PR can be a low-cost, high-return means of raising awareness, understanding and appreciation of an organization, its brands, products, services, activities, and its people.

However, most staff at any given organization typically are not trained in the art of publicity or pubic relations. Thus, it would be useful to develop a comparatively simple and easy-to-implement process to train, or otherwise enable, staff persons to engage in publicity and public relations activities, while at the same time making the process interesting, engaging, and even fun.

### SUMMARY OF THE INVENTION

Provided is a process for developing a publicity plan comprising the steps of:

identifying one or more target audiences;

defining appropriate messages to communicate to each of the identified audiences;

selecting the communication channels to communicate the defined messages to the identified audiences;

determining means of evaluating the results of the publicity plan;

brainstorming ideas about the publicity plan; and

evaluating budgets for the publicity plan,

wherein said process utilizes playing cards to implement each step of the process.

Also provided is a process for developing a publicity plan comprising the steps of:

identifying one or more target audiences by utilizing a collection of potential audiences;

defining appropriate messages to communicate to each of the identified audiences by utilizing a collection of potential messages;

selecting the communication channels to communicate the defined messages to the identified audiences by utilizing a collection of potential communication channels;

determining means of evaluating the results of the publicity plan by utilizing a collection of potential results;

brainstorming ideas about the publicity plan by utilizing a collection of key words; and

evaluating budgets for the publicity plan by utilizing a collection of potential budgets.

Further provided is a process for developing a publicity plan comprising the steps of:

identifying one or more target audiences by using audiences cards listing potential audiences;

defining appropriate messages to communicate to each of the identified audiences by using messages cards listing potential messages;

selecting the communication channels to communicate the defined messages to the identified audiences by using channels cards listing potential communications channels;

determining means of evaluating the results of the publicity plan by using results cards listing potential means of determining results;

brainstorming ideas about the publicity plan by using ideas cards listing terms for inspiring ideas; and

evaluating budgets for the publicity plan by using budgets cards listing potential budgets.

Still further provided is a process for developing a publicity plan comprising the steps of:

A. identifying one or more target audiences including the steps of:

1. selecting a new audiences card from a collection of audiences cards each listing a potential audience;

2. evaluating selected audiences card to determine if the listed audience on the selected audiences card is relevant or useful;

3. setting aside the selected audiences card if it was determined to be relevant or useful;

4. iterating over the steps 1, 2, & 3 until each of the collection of audiences cards have been selected;

B. defining appropriate messages to communicate to each of the identified audiences including the steps of:

5. selecting a new one of the set-aside audiences cards;

6. selecting a new messages card from a collection of messages cards each listing a potential message;

7. evaluating whether the message on the selected messages card is appropriate for communicating to the audience on the selected set-aside audiences card;

8. iterating over the steps F & G until each of the collection of messages cards have been selected; and

9. iterating over steps E, F, G, & H until each of the set-aside audiences cards have been selected;

C. selecting the communication channels to communicate the defined messages to the identified audiences including the steps of:

10. again selecting a new one of the set-aside audiences cards;

11. selecting a channels card from a collection of channels cards each listing potential communications channels;

12. evaluating whether the communications channel on the selected channels card is appropriate for the audience on the selected set-aside audiences card;

13. iterating over the steps 11 & 12 until each of the collection of channels cards have been selected; and

14. iterating over steps 10, 11, 12, & 13 until each of the set-aside audiences cards have been selected;

D. determining means of evaluating the results of the publicity plan including the steps of:

15. selecting a new one of the appropriate channels cards;

16. selecting a results card from a collection of results cards listing potential means of determining results;

17. evaluating whether the potential means of determining results on the selected results card would be effective for the selected appropriate channels card;

18. iterating over the steps 16 & 17 until each of the collection of channels cards have been selected; and

19. iterating over steps 15, 16, 17, & 18 until each of the appropriate channels cards have been selected;

E. brainstorming ideas about the publicity plan including the steps of:

20. selecting a new ideas card from a collection of ideas cards each listing terms for inspiring ideas;

21. perusing the ideas terms on the selected ideas card to brainstorm for ideas; and

22. iterating over the steps 20 & 21 until each of the collection of ideas cards have been selected; and

F. evaluating budgets for the publicity plan including the steps of:

23. selecting a new budgets card from a collection of budgets cards listing potential budgets for the publicity plan;

24. brainstorming publicity plans that fall within the listed budget on the selected budget plan; and

25. iterating over the steps 23 & 24 until each of the collection of budgets cards have been selected.

And still further provided is the above process wherein the results are documented at sub-steps 7, 12, 17, 21, & 24, and wherein sub-step 17 further includes considering and documenting further activities to make measurements more effective.

### BRIEF DESCRIPTION OF THE DRAWINGS

FIG. 1 is a general flow chart showing the Publicity Planning Pack (PPP) process schematically;

FIG. 2A shows two sample “Audience” cards;

FIG. 2B is a flow chart showing how “Audience” cards can be utilized by the process;

FIG. 3A shows two sample “Messages” cards;

FIG. 3B is a flow chart showing how “Messages” cards can be utilized by the process;

FIG. 4A shows two sample “Channels” cards;

FIG. 4B is a flow chart showing how “Channels” cards can be utilized by the process;

FIG. 5A shows two sample “Results” cards;

FIG. 5B is a flow chart showing how “Results” cards can be utilized by the process;

FIG. 6A shows two sample “Ideas” cards;

FIG. 6B is a flow chart showing how “Ideas” cards can be utilized by the process;

FIG. 7A shows two sample “Budget” cards;

FIG. 7B is a flow chart showing how “Budget” cards can be utilized by the process;

FIG. 7C is a flow chart showing an example of how “Budget” cards might be utilized by the process in a larger group setting.

### DETAILED DESCRIPTION OF THE PREFERRED EMBODIMENTS

The Publicity Planning Pack (PPP) includes around 140 cards, an instruction card, and a write on/wipe off pencil. The cards are divided into six color-coded sets, as described in the following Card Table:

TABLE 1
CARD TABLE

| | | |
|---|---|---|
| Orange | Audiences | Shows Potential audiences of various publicity. |
| Green | Messages | Shows Potential Messages to Spread. |
| Blue | Channels | Shows Potential Marketing Channels to use. |
| Pink | Results | Shows ways to Evaluate the Results; |
| Yellow | Budgets | Evaluate How to Approach Different Budgets. |
| Gold | Ideas | Shows Ideas to make marketing interesting. |

Appendix A provides a complete list of the cards that might be utilized in a typical implementation of the method, grouped according to color. However, these cards are merely examples of the types of cards that could be utilized for the method(s) described herein.

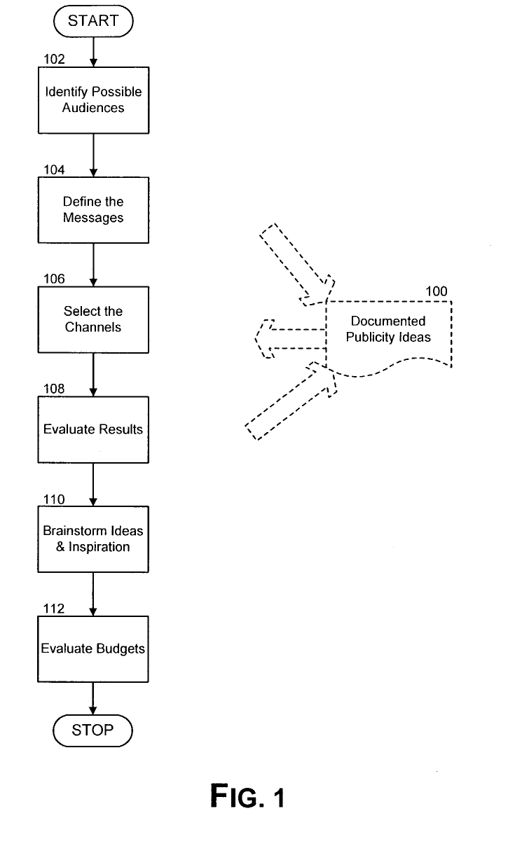

FIG. 1 shows a high-level view of the process according to the invention. The general steps are:

Identify Possible Audiences: This step 102 is basically to identify the potential audiences to which the organization would like to get some message or collection of messages to. Some questions to be answered by participants during this step include: “What audiences might be interested in, or relevant to, your project(s)?” and “Who might be affected by the project(s), either positively or negatively?” Potential “audiences” for evaluation are listed on the orange-faced cards.

Define the Messages: This step 104 is used to determine the types of messages that might be appropriate for the selected audiences. Some questions to be answered by participants during this step include: “What do you really want to say to each of these audiences?” and “What do you want the audiences to believe about you as a result of receiving your messages?” Potential “messages” for evaluation are listed on the green-faced cards.

Select the Channels: This step 106 is used to determine the types of marketing, media, or other communications channels that might be appropriate for the selected audiences. Some questions to be answered by participants include: “Which of these channels could you use to reach each audience?” and “Which channels suggest specific audiences that you might not have thought of before?”. Potential “channels” for evaluation are listed on the blue-faced cards.

Evaluate Results: This step 108 is used for developing criteria and/or processes by which to evaluate the success of a publicity or PR approach. Some questions to be answered by participants include: “How will you know if your activity is succeeding?” and “Which of these measurements could you build into your activity, to show how many people in your target audiences actually received your messages?” Potential “results” for evaluation are listed on the pink-faced cards.

Brainstorm Ideas & Inspiration: This step 110 is used for aiding brainstorming, by using the previously identified information along with key words on the “Ideas” cards, to trigger ideas and inspire solutions that would be useful to the publicity plan. A question to be answered by participants includes: “Might any of the 1,000 or so ‘ideas’ on these cards provide you with the creative spark you need?” Potential “ideas” for evaluation are listed on the gold-faced cards.

Evaluate Budgets: This step 112 is used to evaluate different budgets that might be used to implement the above developed ideas and approaches. Some questions to be answered by participants include: “How much do you really need to spend?” and “Might a different budget give you better ideas?” and “Could a different budget turn a good idea into a great one?” Words intended to inspire “ideas” are listed on the yellow-faced cards.

And finally, the results of the above process should be captured and documented in some manner, such as in a Documented Publicity Ideas 100 document to preserve the ideas and approaches developed during the above process for implementation and archival. This “document” can be implemented using any information storage medium to preserve the results of the process. Such media could include paper, computer documents, copies of white-board writings, tape recordings, video tapes, and any other means of documenting results.

Any of the PPP steps might generate useful information that should be captured in this “document”. The form of the document is less important than the fact that the document should be useful in seeking to preserve (e.g., archive) and implement the final results and decisions generated by the PPP process.

How to use the PPP: Participants can prepare to use the process by educating themselves in publicity and/or PR topics. A familiarization with the basics of setting objectives and defining strategies, can be useful to getting the most out of the PPP process and making it effective. However, such preparation is merely beneficial, but not necessary, to utilizing the process. Further, one should consider the organization and/or any projects that one is involved in and for which the publicity is being sought.

The number of participants can be any number from one, to a large group. If a large group is utilized, the group can be broken up into smaller teams to implement the various sub-processes in some slightly modified fashion useful for larger groups.

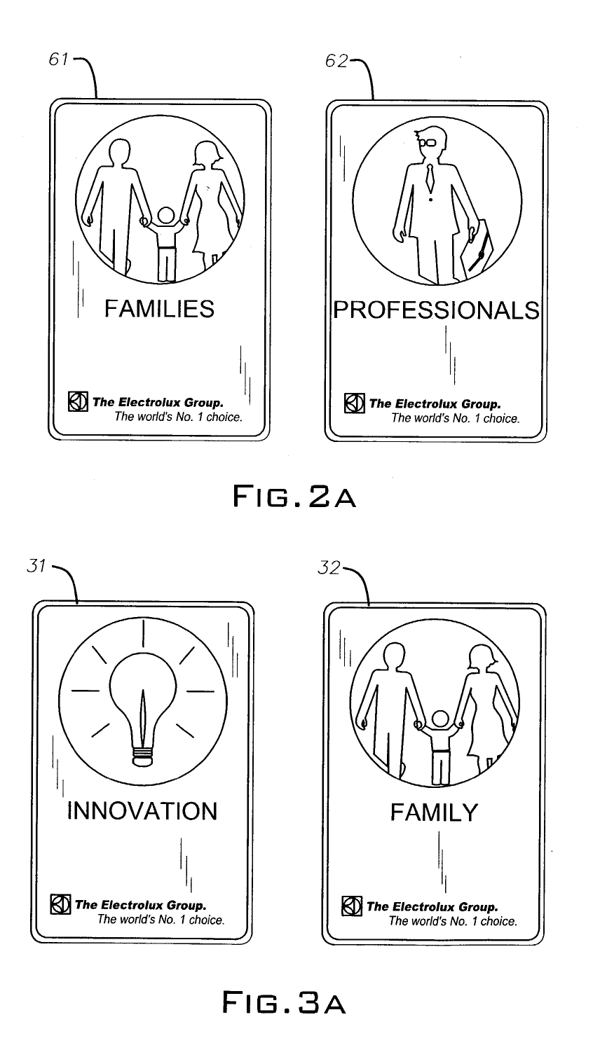

The PPP process starts by having participants Identify the possible audiences. FIG. 2A shows a sample of two of the orange-faced ‘audience’ cards each of which lists a potential audience. The “Audiences” table in Appendix A lists a number of potential audiences cards that are captured by one embodiment of this process.

FIG. 2B is a flow chart showing the steps the participants should take for identifying the possible audiences. The first step 202 is to select an “Audiences” card. The second step 204 is to consider, for the audience listed on the chosen card, whether or not this particular audience is relevant to the organization or project, or whether it could be useful the organization or project. If the audience is determined to be relevant, then the next step 206 is to take the relevant card and set it aside for later use. The next “audiences” card is chosen (step 202), and the process continues (about step 308) until all of the “Audiences” cards have been drawn and evaluated and there are no more “Audiences” cards. The set-aside “audiences” cards will be utilized later in the process.

The process continues with the participants using the set-aside “Audiences” cards and the green-faced “Messages” cards, an example of two of which are shown in FIG. 3A, for defining the messages to be communicated by the PR or publicity to the selected audiences. The “Messages” table in Appendix A lists a number of potential messages cards that are captured by one embodiment of this process.

FIG. 3B is a flow chart showing the steps the participants should implement for defining the messages. The first step 302 is to take one of the set-aside “Audiences” cards. The next step 304 is to select one of the green-faced “Messages” cards. The next step 306 is to determine if the message listed on the selected “Messages” card is appropriate for the audience on the chosen “Audiences” card. If the message is appropriate, the next step 308 is to document the appropriate message and audience in some manner that can be preserved (such as in the document 100). Then, if there are additional “Messages” cards (step 310), another “Messages” card is chosen (step 304) for evaluation against the same “Audiences” card (steps 306 & 308). This iterative process continues until all “Messages” cards have been evaluated the chosen set-aside “Audiences” card.

If there are additional set-aside “Audiences” cards (step 312), the “Messages” cards should probably be shuffled (step 314) to keep the selection process random, and then the next set-aside “Audiences” card is chosen (step 302), and the above iterative process continues (about steps 310/312) until each of the set-aside “Audiences” cards have been finally compared to all of the “Messages” cards (step 306), and the results documented (at step 308).

Participants should be told to remember that they will not necessarily want to communicate the same messages to every audience—for example, the messages for a new product launch might be ‘new, innovative, hassle-free’ for an audience of housewives, and ‘new, profit, leadership’ for an audience of retailers. It is not necessary to be specific about the messages; instead, identify the words which give the correct overall focus and tone to be portrayed.

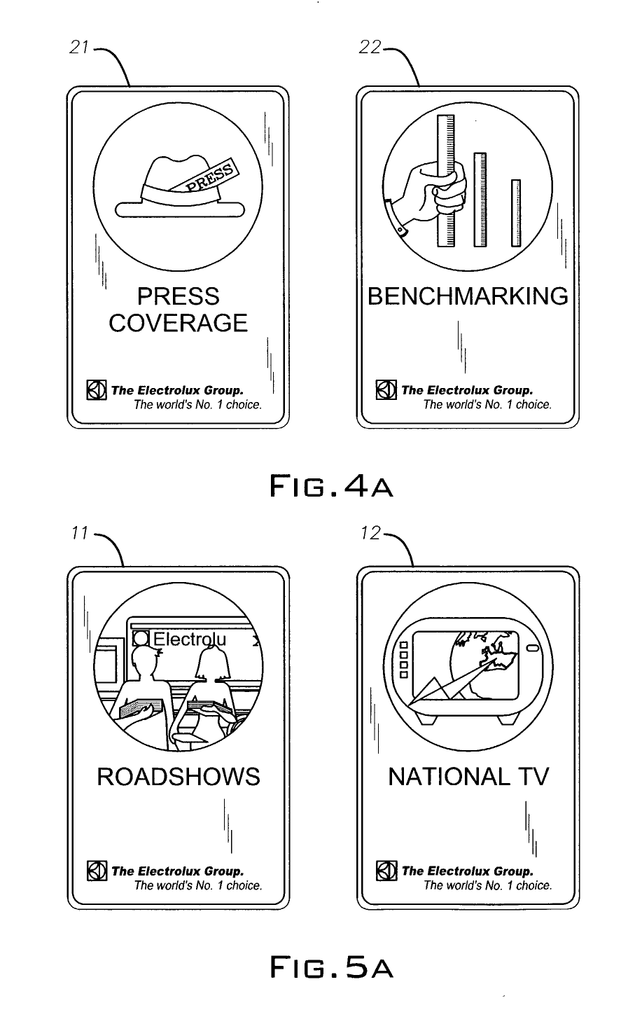

The process continues with the participants again using the set-aside “Audiences” cards and the blue-faced “Channels” cards, an example of two of which are shown in FIG. 4A, for defining the potential communications channels to be utilized by the PR or publicity. The “Channels” table in Appendix A lists a number of potential communications “channels” cards that are captured by one embodiment of this process.

FIG. 4B is a flow chart showing the steps that participants should use for defining this part of the process. The first step 402 is to take one of the set-aside “Audiences” cards. The next step 404 is to select one of the blue-faced “Channels” cards. The next step 406 is to determine if the communications channel listed on the selected “Channels” card is appropriate for the audience on the chosen “Audiences” card. If the channel is appropriate, the next step 408 is to document the appropriate communications channel and audience in some manner that can be preserved (such as in the document 100). Participants should think through the various channels and consider which channels they could use to reach each audience on the set-aside “Audiences” cards. It is useful to think laterally in this process, and to remember that non-consumer audiences (such as retailers, customers or financial analysts) are also users of consumer media—such as TV, radio and newspapers. As a result, it is often possible to reach ‘corporate’ audiences through ‘consumer’ media.

An acceptable “Channels” card is set aside (step 410). Then, if there are additional “Channels” cards (step 412), another “Channels” card is chosen (step 404) for evaluation against the same set-aside “Audiences” card (steps 406 & 408). This process continues until all “Channels” cards have been evaluated against the chosen set-aside “Audiences” cards.

If there are additional set-aside “Audiences” cards (step 414), the unused “Channels” cards should probably be shuffled (step 416) to keep the process random and exciting. Further, the pile of set-aside “Channels” cards could also be shuffled (also step 416—but they should remain on the set-aside pile to keep them separate) and then the next set-aside “Audiences” card is chosen (step 402), and the above iterative process continues (about steps 412/414) until each of the set-aside “Audiences” cards have been finally compared to all of the “Channels” cards (step 406), and the results documented (at step 408).

Participants should note that there are many channels open to them other than just a generalized ‘the media’, with channels including the internet, roadshows, direct mail, television, radio, printed media, and dozens of others. See the Channels table of Appendix A for more examples.

The process continues with participants using the set-aside “Channels” cards and the pink-faced “Results” cards, an example of two of which are shown in FIG. 4A, for defining the messages to be communicated by the PR or publicity. The “Results” table in Appendix A lists a number of sample “Results” cards that are captured by one embodiment of this process.

FIG. 4B is a flow chart showing the steps to be taken by the participants for determining the results techniques. The first step 502 is to take one of the set-aside “Channels” cards. The next step 504 is to select one of the pink-faced “Results” cards. The next step 506 is to determine if the result listed on the selected “Results” card is appropriate or useful for the communications channel on the chosen set-aside “Channels” card. For each channel, participants should decide which of the techniques they could use to monitor and evaluate success. For example, if national and regional daily newspapers have been identified as a key channel, the key measurement technique could be press cuttings: how many, how large and prominent they are, whether they have a branded photograph in them, and so on.

If the result technique is determined to be appropriate, the next step 508 is to document the appropriate result and corresponding channel in some manner that can be preserved (such as in the document 100). At this stage, participants should consider further activities to make a results measurement more effective (step 510). For example, if roadshows are a primary channel, the number of people attending each roadshow could be determined. However, this doesn't say anything about attendees reactions to the roadshow. But if “money off” vouchers were given away to all roadshow attendees, the number of vouchers redeemed could be monitored, and hence the roadshow could be related to the number of sales it generated. These considerations should also be documented (in document 100, for example).

Continuing the process, if there are additional “Results” cards (step 512), another “Results” card is chosen (step 504) for evaluation against the same “Channels” card (steps 506, 508 & 510). This continues until all “Results” cards have been evaluated against the chosen set-aside “Channels” card.

If there are additional set-aside “Channels” cards (step 514), the “Results” cards should probably be shuffled (step 516) to keep the process unpredictable, and then the next set-aside “Channels” card is chosen (step 502), and the above iterative process continues (about steps 512/514) until each set-aside “Audiences” card has been finally compared to all of the “Messages” cards (step 506), and the results documented (at steps 508, 510).

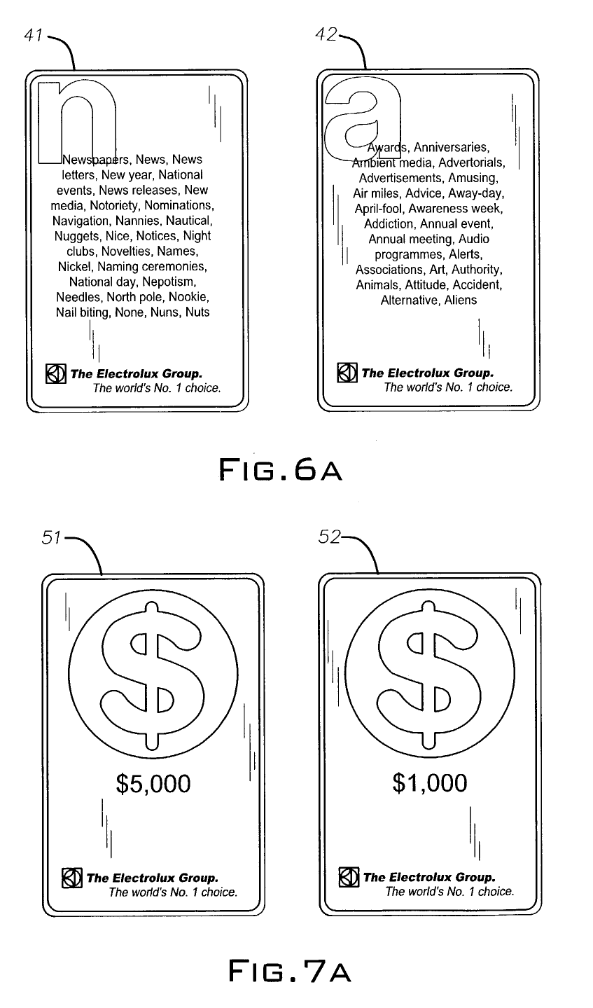

The process continues by utilizing “Ideas” cards to aid participants in brainstorming. FIG. 6A shows a sample of two of the gold-faced “Ideas” cards that provide terms to brainstorm over. The “Ideas” table in Appendix A lists a number of potential ideas cards that are captured by one embodiment of this process.

FIG. 6B is a flow chart showing the steps for participants undergoing this brainstorming process. Step 602 is to select an “Ideas” card. Then, step 604 is to read the various terms on the card, and brainstorm as to whether or not any of these words provide inspiration as to ideas that are relevant to the organization or project (step 606). Participants should seek inspiration for the creative spark that will enable the organization to attract the interest of a journalist or consumer or act as the focus of the campaign.

As an example, imagine the goal of launching a new, super-silent vacuum cleaner (VC), and the decision has been made to target “families” with a core message “time saving and convenience”, and that the channels chosen are through “regional newspapers” and “consumer magazines”.

Drawing the ‘T’ “Ideas” card at random, ask the question “what ideas are suggested?” The table below shows four of the 51 ideas on the card that might be inspired:

TABLE 2
Ideas Card Example

| Idea | Possible use |
|---|---|
| TV | Position the new VC as ‘the VC you can use and watch TV |
| | at the same time!’ A great bonus for busy soap opera |
| | addicts . . . |
| Telephones | Describe the new VC as ‘the VC you can use while you're |
| | on the phone!: Why waste time just doing the cleaning, |
| | when you could chat to a friend at the same time?’. Link |
| | with a consumer magazine to run a competition, offering |
| | prizes of a new super-silent VC and a ‘hands free’ domestic |
| | telephone with a headset . . . |
| Teenagers | Announce ‘the greatest invention ever for lazy teenagers: |
| | ‘now your mum can clean your room without even waking |
| | you up!’; issue as a press release along with light-hearted |
| | but serious ‘top ten tips for living with a teenager’; issue |
| | fun photo of typical (i.e.: messy . . . ) teenager's bedroom |
| Theater | Press release to announce ‘the vacuum cleaner that's quiet |
| | enough to use during a play performance’; donate a super- |
| | silent VC free to local/national theatres or theatre |
| | companies; issue fun photo of top stage actor performing |
| | while someone vacuums around them . . . |

Any of these ideas might turn an otherwise dull “new product announcement” into a press release that will grab the attention of the target audience's favorite media.

If participants are brainstorming publicity ideas with a small group of people, each person could draw one or two Ideas cards at random to get a broader range of ideas. Participants could also trade cards or discuss the ideas out loud, to gain a larger perspective. Larger groups might break into smaller groups (teams) to perform this task.

Any good ideas should be captured (step 608) as in a document 100, for example. The next “Ideas” card is chosen (step 602) (or if multiple individuals are participating, each might choose an additional card), and the process continues (about step 610) until all of the “Ideas” cards have been drawn and evaluated and there are no more cards, and all good ideas have been documented (step 608).

Finally, the process ends by considering budgets for the publicity plan. It is very important to remember that although publicity can work at very low cost, it does generally require some level of budget—for example, for photography, mailings, PR agency fees, and so on. However, it is equally important to remember that a more expensive idea is not necessarily a better idea, and that a bigger budget will not automatically ensure a more effective campaign.

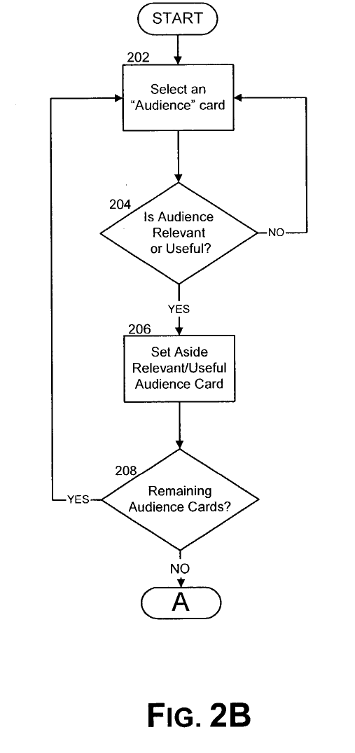

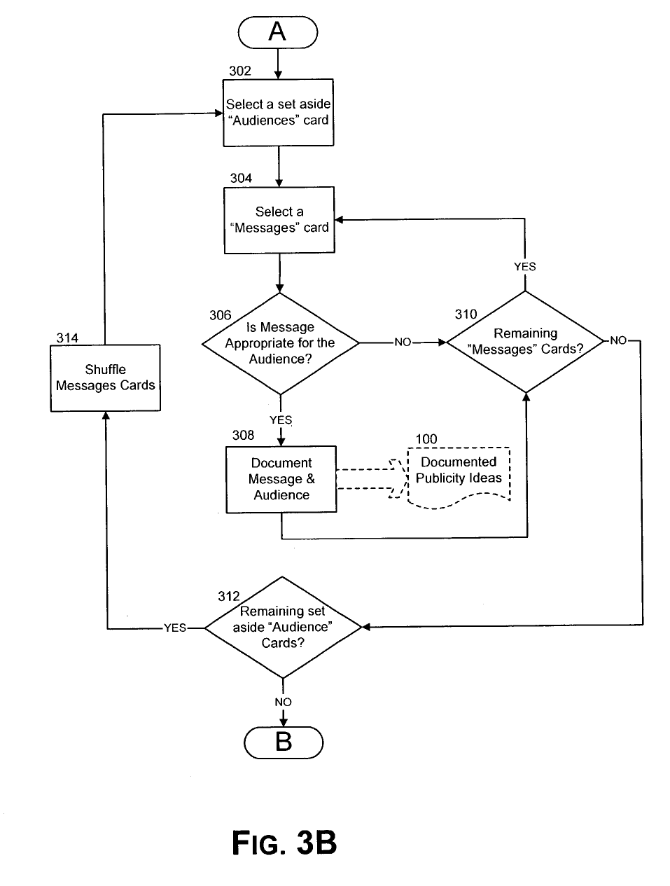

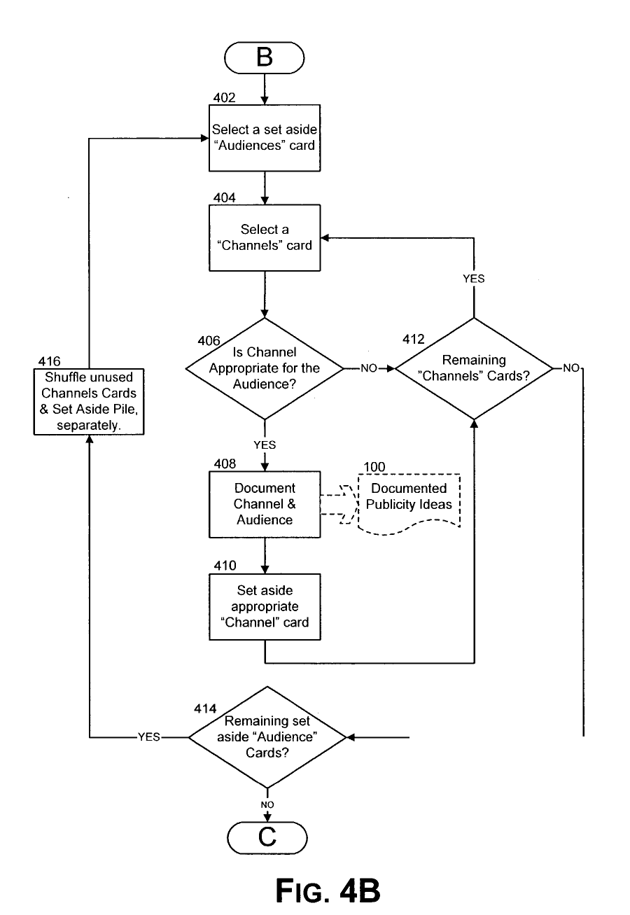

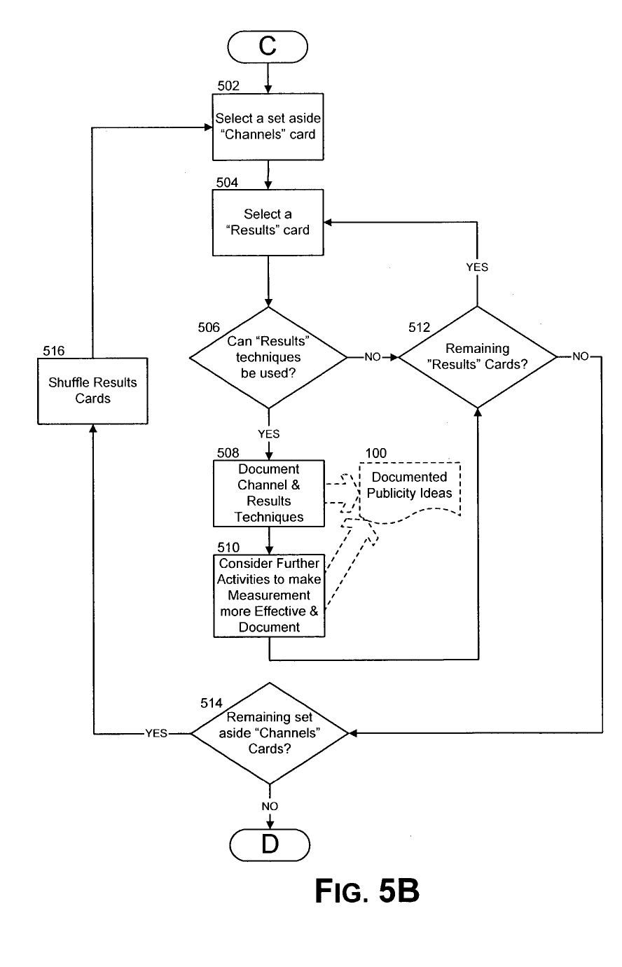

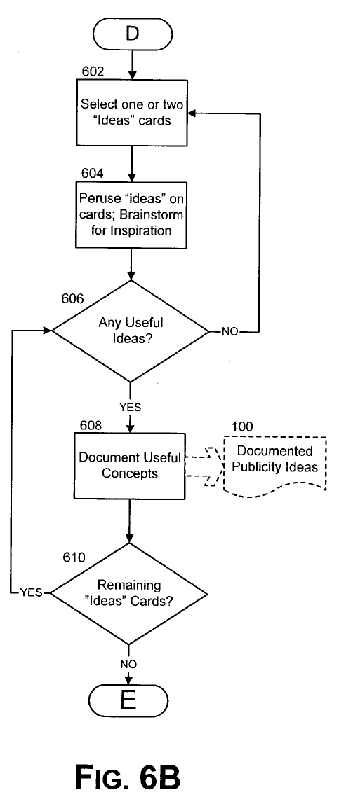

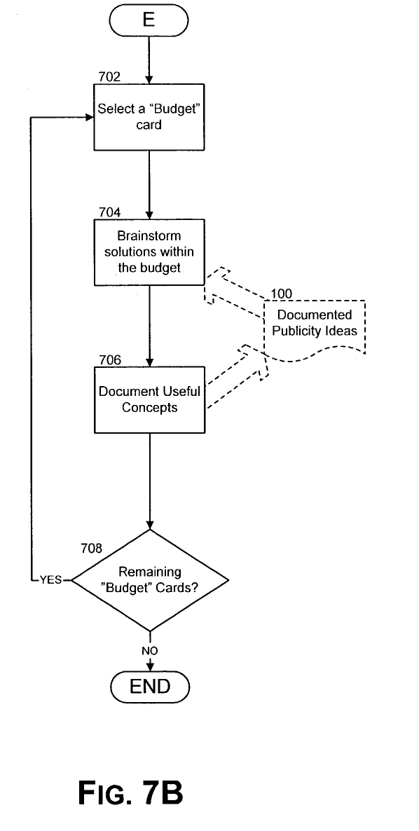

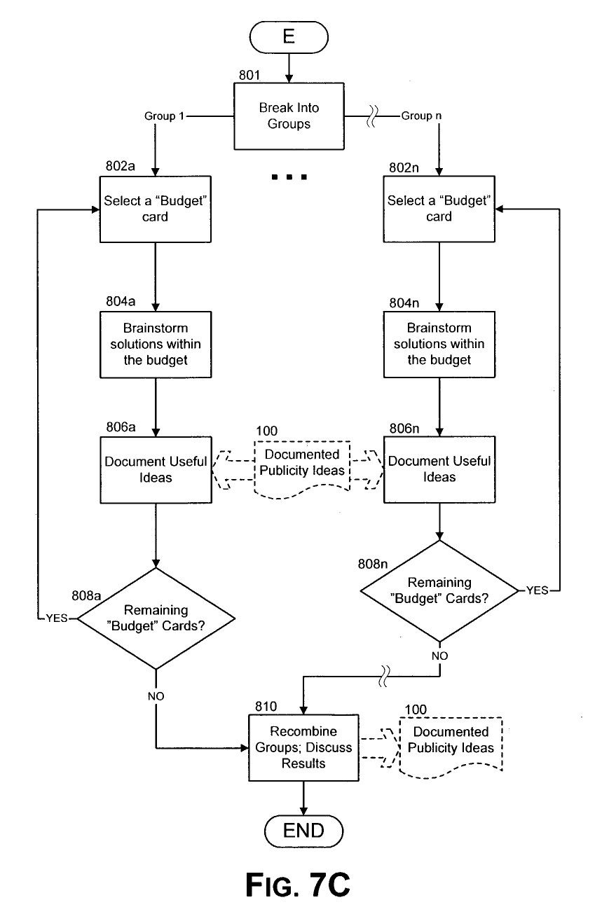

The gold “Budget” cards, an example of two of which are shown in FIG. 7A, are useful for developing publicity plan of various costs. FIG. 7B shows a flow chart describing one way in which to use the budget cards. A budget card is selected (step 702). The various concepts captured in document 100 are brainstormed with the selected budget on the budget card kept in mind. Useful concepts within the listed budget are documented (in document 100), and another budget card is chosen (step 702). This process can be repeated a number of times (about step 708), until all budget cards have been evaluated. The documented results of this PPP process (captured in document 100) can then be used to implement a publicity or PR plan based on those documented results.

Another way of using is to give the same brief (audience, messages, channels, etc. documented in the document 100) to two different people or groups, and give each a different ‘Budget’ card to work with.

There are many modifications that could be made to the above process. In particular, if there are many participants, the participants might be broken into teams, and the teams individually practice many of the PPP process steps. For example, FIG. 7C shows an alternative means to evaluate budgets. In this alternative, when multiple participants are involved, the participants can be broken up into teams (step 801). Then, each team selects a budget card (steps 801a . . . 802n), brainstorms ideas (steps 804a . . . 804n), documents the ideas (steps 806a . . . 806n), and continues on with the process (about steps 808a . . . 808n) until all budget cards are utilized. Finally, the team groups can recombine and discuss the results of their individual efforts. The best results are then documented in the document 100.

Any of the above steps might be modified to accommodate the team concept, similar to the example listed above. The PPP process can also be used for a number of additional purposes, including general staff training, and internal communications. Accordingly, the PPP process can be utilized by the staff of organizations to develop a useful and economical publicity plan.

The invention has been described hereinabove using specific examples of steps and sample cards; however, it will be understood by those skilled in the art that various alternative steps may be used and equivalents to the cards may be substituted, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

### Appendix A

| | |
|---|---|
| Card | Description |

Orange “Audiences” Cards:

| | |
|---|---|
| Single Women | Walking woman carrying a purse |
| Rich People | Auto, credit cards, diamond ring, dollar signs, coins |
| Children | Three children playing with a ball |
| Housewives | Woman wearing apron |
| Couples | Man and woman holding hands |
| Retailers | Man sitting behind computer, books on shelf behind man |
| Dinkys | Man and woman holding hands, dollar signs, coins |
| Local Residents | Couple holding hands, children playing with ball, houses in background |
| Grannies | Two old women |
| Single Men | Man wearing hard hat |
| Media | Man holding video recorder |
| Government | Building resembling the White House |
| Investment Analysts | Man in suit, documents, life line through center |
| Environmental | World, word “Environment”, leaves on the end of a branch |
| Organisations | |
| Consumer Organisations | Bag with outlined shirt on it, label reading “Consumer Association”, |
| Cash Rich, Time Poor | Dollar sign inside a stop clock with partial clock showing |
| Newlyweds | Bride and groom |
| Employees | Man in business suit holding briefcase |
| Teenagers | Group of four teens |
| People Who Can't Cook | Hand dumping food from a plate into a garbage can |
| Professionals | Man in business suit with tie and glasses holding briefcase |
| Families | Father and Mother on each side of child, holding kid's hand |
| Retired People | Old man with cane and old woman with purse |
| People With Hobbies | Man with saw, hard hat and “D.I.Y.” on shirt, Woman with piano |
| | keys and music notes |

Green “Messages” Cards:

| | |
|---|---|
| Innovation | Light bulb “shining” |
| Family | Father and Mother holding a child's hand |
| Quality of Life | Beach setting with clouds, water and people under umbrellas |
| Value for Money | Scale with refrigerator on one side and dollar signs on the other |
| Status | Male with royal robe and crown facing right |
| New | Shirt with swirl on it and price tag on sleeve |
| Luxury | Male silhouette with bottles of wine and wine glasses on table in front |
| | of him |
| Exclusive | Car with hood ornament (R inside a circle with wings on circle) |
| Leader | Indian chief |
| High-Tech | Monitor, keyboard, mouse, satellite |
| Opportunity | An open door revealing the sun, mountains and grass |
| Hassle-Free | Male silhouette making okay sign with right hand |
| Unique | Shining diamond |
| Confidence | Hand with thumb up |
| Special | Box with ribbon wrapped around it and bow tied on top |
| Traditional | Capital “T” outlined |
| Change | Dot → cocoon → caterpillar → butterfly (life cycle of butterfly) |
| Eco-Friendly | Sun, mountains, tree, leaves |
| Healthy | Bottle of milk, fish, apple, oranges |
| Profit | Three bags with dollar sign on each one |
| Internet | “http://”, “www.com”, black circle, lt. green lines with dk. Green |
| | circles at end of lines |
| Bigger | Blue mouse and grey elephant |
| Imported | World with white graph lines, two white dots with red dotted line |
| | connecting both |
| Cheap | Words “ONLY $1.00” with yellow flash behind |

Pink “Channels” Cards:

| | |
|---|---|
| Press Coverage | Dk. brown derby had with lt. brown stripe around it and a white |
| | “PRESS” tag sticking out of the lt. brown stripe |
| Sales | Chart showing “+6% and UP arrow” above the Blue portion, “+23% |
| | and UP arrow” above the Pink portion, “−11% and DOWN arrow” |
| | above the Green portion and “−9% and DOWN arrow” above the |
| | Orange portion |
| Sampling | Hand holding two coupons, top coupon reads “Try This Free!” |
| Benchmarking | Hand holding tallest of three rulers, rulers decrease in size |
| Retailer Enquiries | Male silhouette with “?”, “i” inside a circle by his head and a caption |
| | bubble coming from his mouth |
| U & A Research | Male silhouette with caption bubble, using yellow pointer for the |
| | screen entitled “Research”, standing in front of a crowd |
| Calls to Freephone | Telephone symbol, “0800-345-453”, “0800-123-1” and “0800-345-453” |
| Website Hits | Box with 2 arrows tip-to-end, sphere with lines, “You are no.” above 8 |
| | side-by-side squares reading “00113069” above “visitor of this site” |
| Staff Survey | Cover of “Your Opinion” and “Employees” booklets |
| Roadshow Attendance | Three male and one female silhouettes in front of a truck with |
| | “Electrolux” on the side |
| Journalist Surveys | Cover of “What do you think?” and “Journalist” booklets |
| Brochure Requests | Grey envelope with green postage square reading “Brochure Request” |
| | and an open booklet with checked box on the right side |
| Customer Research | Green clipboard with red-tipped, blue pen attached to the clipboard, |
| | page entitled “Report” on the clipboard |
| Competition Entries | Paper with “WIN” on top, “Send your entries NOW!” on the bottom |

Blue “Results” Cards:

| | |
|---|---|
| National TV | Red TV with world on the screen, Europe outlined in white, four |
| | squares on left of screen - second down is yellow, others are white |
| Roadshows | Man and woman holding papers with “Electrolux” sign in background |
| International Newspapers | Front page of World News and front page of International Daily |
| | Newspapers |
| Posters | Poster with words “Now Showing”, “Preview” and “at ABC Cinema” |
| Viral Marketing | Single male branching off to eight people, branching off to more |
| | people |
| Gardening Magazines | Front cover of magazine entitled “Gardening” with flower and fork on it |
| “Best Buy” Magazines | Front cover of “Which” and “Best Buy” magazines, covers contain |
| | down arrows, dollar signs and check boxes with checks |
| National Newspapers | Cover of “National” and “UK Special” newspapers |
| Cookery Magazines | Cover of “Cookery” magazine containing plate with eggs, sausage, |
| | greens and a pancake |
| Interior Design Magazines | Cover of “Interior” and “Urban Spa . . . ” magazines |
| Local Newspapers | Cover of “Your Street” and “Local” newspapers |
| Ambient Media | Brick wall with “Concert”, “Now Showing” and “Grand” posters on it |
| Business Magazine | Cover of “World Trade” and “Economics” magazines |
| Consumer Magazines | Cover of “Your Choice” magazine |
| Direct Mail | “Christmas Shopping” magazine, “My jewellery” catalogue and white |
| | envelope |
| Hobby Magazines | Cover of “Motors” and “Music today” magazines |
| Local TV | Brown TV with world on screen, two white dots, one red dot, one blue |
| | dot, four squares on left of screen - third down is red, others are white |
| Local Radio | Brown radio with world in the background, big white dot in Europe |
| | with one yellow triangle pointing to the dot and one pointing to the |
| | radio antenna |
| National Radio | Purple radio with world in the background, Europe outlined in white |
| | with one yellow triangle pointing to Europe and one pointing to the |
| | radio antenna |
| Trade Press | Covers of “Electrolux Wins Awards” and “Winning Ways” |
| | newspapers, bottom of covers are torn |
| Word of Mouth | A purple and a blue male silhouette with empty caption bubbles |
| | coming from the mouth |
| Sponsorship | Male figure wearing an orange and white short sleeve shirt and green |
| | shorts (shirt contains the number 6 in the middle with “Electrolux” |
| | above it |
| Internet | “http://”, “www.com”, background contains an incomplete blue circle, |
| | an incomplete purple circle, a green rectangle and two green lines with |
| | a circle outlined in dk. green at the end of each |
| Consumer Technology | Covers of “GO DIGITAL” and “PC MONTHLY” magazines |
| Magazines | |

Gold “Budget” Cards:

| | |
|---|---|
| $1,000 | $ |
| $5,000 | $ |
| $10,000 | $ |
| $50,000 | $ |
| $100,000 | $ |
| $500,000 | $ |

Yellow “Ideas” Cards:

| | |
|---|---|
| “a” | Awards, Anniversaries, Ambient media, Advertorials, Advertisements, Amusing, Air |
| | miles, Advice, Away-day, April-fool, Awareness week, Addiction, Annual event, |
| | Annual meeting, Audio programmers, Alerts, Associations, Art, Authority, Animals, |
| | Attitude, Accident, Alternatives, Aliens |
| “b” | Brochures, Billboards, Balloons, Birthdays, Banners, Books, Badges, Briefing, |
| | Borrow, Buzzard, Buses, Bulletins, Barbecue, Beauty contests, Balls, Breakfasts, |
| | Buffets, Brollies, Bribery, Brainstorm, Budget, Brand partners, Bargains, |
| | Broadcasting, Branding, Balloon rides, Bums, Battles |
| “c” | Celebrities, Charities, Competitions, Conferences, Cards, Catalogues, Contests, Case |
| | studies, Campaigns, Collections, Cookery, Candid camera, Canvassing, Cover mounts, |
| | Community, Commercials, Concerns, Costumes, Caps, Colleges, Clubs, Coupons, |
| | Cowpats, Consumers, Crisis, CDs, Cause-related, Circulars, Committees, Challenges, |
| | Celebrations, Chat rooms |
| “d” | Demonstrations, Discounts, Draws, Deadlines, Days, Day trips, Dinners, Dates, |
| | Diaries, Displays, Debates, Data analysis, Designers, Direct mail, Dictionaries, |
| | Documentaries, Donations, Dogs, DJs, Dedications, Discos, Dignitaries, Deaths, |
| | Disasters, Diversification, Demographics, Dinosaurs |
| “e” | Events, Exhibitions, Evaluation, Examples, Endorsements, E-mail, E-commerce, |
| | Elections, Expeditions, Euro, Europe, Exclusives, Experts, Embargoes, Entertainment, |
| | Editorial, Employees, Ethics, Excellence, Expose, Evenings, Enticements, Expositions, |
| | Explosions, Electronic press hit, Energy saving, Ethnic minorities, England |
| “f” | Features, Freebies, Festivals, Films, Fame, Fads, Fashion, FAQs, Fun runs, Football, |
| | Focus, Focus groups, Fund raising, Frisbees, Forums, Facts and figures, Flagdays, |
| | Foreigners, Family tree, Fly-bys, Family fun days, Fax, Fan clubs, Furniture, |
| | Fireworks, Financial reports, Face-to-face, Funbags, Firsts, Fire, Fact-file, Fashion |
| | show, Fame, Freelancers, Flood, Famine, Fabulous, Funding |
| “g” | Gifts, Guests, Gatherings, Give-aways, Galas, Gurus, Galleries, Games, Good news, |
| | Guides, Government advice, Guerrilla marketing, Goodies, Grand opening, Grand |
| | parents, Gossip, Guest appearances, Genius, Green, Goodwill, Gimmicks, Golf, |
| | Giraffes, Grannies, Graphs, Ground breaking, Guided tours, Gastronomy, Gardens, |
| | Gongs, Gargantuan, God, Gold, Graphics, Gender, Globalization, GM foods |
| “h” | Holidays, Health, Handouts, Hotlines, Helpdesks, Helplines, Hang-gliding, |
| | Heatwaves, Horse racing, Hot air balloons, Hampers, Hijacking, Hoarding, |
| | Hospitality, Homepage, Hospitals, Home shopping, Hot issues, Huge, Hobbies, |
| | Horizontal press, Hire, Humour, Horror, Human interest, Hysteria, Height, Happiness, |
| | Hotels, Helium balloons, Haggis, Hip Hyena, History |
| “i” | Internet, Intranet, Issues, Invitations, Initiatives, Interviews, Incentives, Internal, |
| | Indispensable, Innovative, Inexpensive, Influences, Industry comment, Information, |
| | In-house, Interior design, Inauguration, Igloos, Ice-sculpture, Images, Interactive, |
| | Instruction, Inheritance, In-store, Illegal, International, Interrogation, In-people, IT- |
| | girls, Intelligent living |
| “j” | Junkets, Joint ventures, Jokes, Jesus, Journalist trips, Jumble sale, Jives, Jazz, |
| | Juxtaposition, Junk bonds, Judges, Jollies, Junk food, Jumps, Jingles, Joint promotion, |
| | Jail breaks, Jamboree, Joker, Jargon, Jelly, Jaunt, Job |
| “k” | Key issues, Kissing, Kissathon, Kick-boxing, Kiss and tell, Key media, Knees-up, |
| | Kick-off, Kudos, Kindness, Kites, Kung-fu, Karaoke, Knowledge, Killings, Kidnap, |
| | Kangaroo, Kings, Kittens |
| “l” | Leadership, Launches, Lunch, Lobby, Lab tests, Leaflets, Loans, Love, Lust, Letters, |
| | Lies, Line dancing, Logos, Lift-off, Lollipops, Lasers, Lap dancing, Largest, Longest, |
| | Laptop, Library, Legality, Landmarks, Lobbying, Last, Leadtimes, Lottery, Lost & |
| | found, Labels, Linguistic, Language, Learning, Laughter, London, Lucrative, License, |
| | Lamas, Llamas, Lemurs, Lemons, Leapfrog |
| “m” | Meetings, Magazines, Mail-outs, Mailshots, Months, Milk cartons, Milestones, Magic |
| | Millionaires, Media briefings, Media relations, Music, Museums, Money, Market |
| | research, Multicultural, Multinational, Makeovers, Money advice, Monkeys, MPs, |
| | Mishaps, Marches, Memorials, Memories, Mascots, Marathons, Merchandising, |
| | Messages, Medical, Movies, Marriage, Murder, Mayday, Mine, Minimum, Maximum, |
| | Master class, Money off, Mice |
| “n” | Newspapers, News, News letters, New year, National events, News releases, New |
| | media, Notoriety, Nominations, Navigation, Nannies, Nautical, Nuggets, Nice, |
| | Notices, Night clubs, Novelties, Names, Nickel, Naming ceremonies, National day, |
| | Nepotism, Needles, North pole, Nookie, Nail biting, None, Nuns, Nuts |
| “o” | Opinion pieces, One-to-ones, Oaks, Oscars, Official endorsements, Olympics, Open |
| | days, Oldest, On-pack promotions, Opinion leaders, Openings, Offers, Originality, |
| | Origins, On-line, Overseas trips, Opinions, Odour, Oracle, Outings, Ornaments, |
| | Ospreys, Ostriches, Off the wall, Out of the box, Observers, Oil, One-stop, Ostracise, |
| | Outcry, Official, Off-line, Outdoors |
| “p” | Press release, Press kit, PR, Postcards, Post-it notes, Posters, Pamphlets, Premieres, |
| | Point of sale, Personalities, Piss-ups, Parties, Product placement, Product reviews, |
| | Points, Prizes, Promotions, Politicians, Publicity, Presentations, Poetry, Philosophy, |
| | Photoshoot, Photography, Photocall, Puns, Press packs, Press conferences, Partners, |
| | Postage stamps, Presents, Profiles, Protests, Personal appearances, Parades, Parents, |
| | Police, Passion, Perspective |
| “q” | Questionnaires, Quantitative, Qualitative, Q + A, Queen, Quizzes, Quebec, Quotes, |
| | Question time, Quality circles, Quality time, Qualifications, Quotas, Queries, Quirks, |
| | Quest, Quantity, Queues |
| “r” | Radio, Research, Reviews, Roadshows, Royalty, RNRs, Records, Record breakers, |
| | Raffles, Reader offer, Races, Rallies, Racism, Raves, Real-life stories, Results, |
| | Relationships, Rules, Releases, Random, Reaction, Retirements, Retrospectives, |
| | Receptions, Roundabouts, Robberies, Rich list, Riot, Rock & roll, Representation, |
| | Rolls-Royce, Romance, Rage |
| “s” | Sports, Societies, Sponsorship, Society, Sales, Stunts, Speakers, Special days, |
| | Specialist press, Streakers, Solstice, Symbols, Supermarkets, Sit-ins, Samples, Shows, |
| | Strikes, Service, Seminars, Strategy, Statistics, Spoofs, Signings, Satire, Supplements, |
| | Scandals, Sunday-for-Monday, Success stories, Stamps, Satellites, Spain, |
| | Scholarships, Safety, Sarongs, Songs, Social Responsibility, Stars, Spokespeople, |
| | Scientific, Seasonal, Statues, Statutes, Supermodels, Superlatives |
| “t” | TV, Trade shows, Treasure hunts, Trucks, Thongs, Training, Trains, Taxis, Tickets, |
| | Trend-setters, Trips, Tequila night, Top ten, Tips, Topical, Teleconferences, Timing, |
| | Telephones, Tissues, Third party endorsement, Tours, Talks, Teenagers, Taste, |
| | Tastings, Tennis, Travel, Try + buy, Trade press, Tournaments, Technical, Themes, |
| | Testimonial, Tennis, Tools, Tests, Trials, Tragedy, Tried and Tested, Trauma, Teaser, |
| | Titillation, Tax, Theatre, Tea, Tokens, Tycoon, Typhoon |
| “u” | Umbrellas, Uniforms, Underwear, Unions, Universities, USPs, User tracking, |
| | Underground, Universal, Upgrading, Uplifting, Unexpected, U-turns, Underdog, |
| | Unique, Unveiling, Unleashing, Undercover, Unusual, Unofficial, Undiscovered, |
| | Uncensored, Undermine, Uruguay, Ulan Bator |
| “v” | Vouchers, VNRs, Vehicles, Videos, VAT, Visitors, Vertical press, Victories, Viagra, |
| | Velocity, Venus, Virtual reality, Virtue, Value-added, Value for money, Value |
| | creation, Vote, Visibility, Vigilante, Valentine, Verbal, Venue, Vindicate, Vast, Vocal, |
| | Visit, Violent, Vulgar, Velvet, Volvo, Verdict, Vulnerable, Void |
| “w” | Website, Webcast, Webcam, Weeks, Walks, World record, Window displays, Wishes, |
| | Wins, Weather, Wind, Waves, Winners, Weekends, Writing, Word of mouth, |
| | Watchdog, Witch hunt, Workshop, Wraparound, Wap phones, Weddings, William |
| | (Prince), Wellington boot, Welcome, Whizzkids, Wickedness, Wit, Wacky, Weird, |
| | Woolly, Wonderful, Wealthy, Wild animals, Why, When, Where |
| “x” | Xmas, Xenophobia, X-rated, X files, X-ray, Xerox, Xylophone, X marks the spot |
| “y” | Youth, Yachting, Years, Youngest, Yearly, Yoga, Yogurt, Yodelling, You, Yesterday, |
| | Young people, yet to be discovered, Yetis, Yobs, Young, Yo-yo, Yes, Yellow |
| “z” | Zoos, Zones, Zen, Zeus, Zany, Zip-code, Zodiac, Zygotes, Zealots, Zion, Zeppelin, |
| | Zebedee, Zest, Zeal, Zoon |

what is claimed is:

1. A process for developing a publicity plan comprising the steps of:
identifying one or more target audiences;
defining appropriate messages to communicate to each of the identified audiences;
selecting the communication channels to communicate the defined messages to the identified audiences;
determining means of evaluating the results of the publicity plan;
brainstorming ideas about the publicity plan; and
evaluating budgets for the publicity plan, wherein said process utilizes playing cards to implement each step of the process.

2. The process of claim 1 further comprising the step of documenting the results of the previous steps for aiding in the implementation of the publicity plan.

3. A process for developing a publicity plan comprising the steps of:
identifying one or more target audiences by utilizing a collection of potential audiences;
defining appropriate messages to communicate to each of the identified audiences by utilizing a collection of potential messages;
selecting the communication channels to communicate the defined messages to the identified audiences by utilizing a collection of potential communication channels;
determining means of evaluating the results of the publicity plan by utilizing a collection of potential results;
brainstorming ideas about the publicity plan by utilizing a collection of key words; and
evaluating budgets for the publicity plan by utilizing a collection of potential budgets.

4. The process of claim 3 further comprising the step of documenting the results of the previous steps for aiding in the implementation of the publicity plan.

5. The process of claim 4, wherein said process utilizes playing cards to implement the process.

6. The process of claim 3, wherein said process utilizes playing cards to implement the process.

7. A process for developing a publicity plan comprising the steps of:
identifying one or more target audiences by using audiences cards listing potential audiences;
defining appropriate messages to communicate to each of the identified audiences by using messages cards listing potential messages;
selecting the communication channels to communicate the defined messages to the identified audiences by using channels cards listing potential communications channels;
determining means of evaluating the results of the publicity plan by using results cards listing potential means of determining results;
brainstorming ideas about the publicity plan by using ideas cards listing terms for inspiring ideas; and
evaluating budgets for the publicity plan by using budgets cards listing potential budgets.

8. The process of claim 7 further comprising the step of documenting the results of the previous steps for aiding in the implementation of the publicity plan.

9. A process for developing a publicity plan comprising the steps of:
A. identifying one or more target audiences including the steps of:
1. selecting a new audiences card from a collection of audiences cards each listing a potential audience;
2. evaluating selected audiences card to determine if the listed audience on the selected audiences card is relevant or useful;
3. setting aside the selected audiences card if it was determined to be relevant or useful;
4. iterating over the steps 1, 2, & 3 until each of the collection of audiences cards have been selected;
B. defining appropriate messages to communicate to each of the identified audiences including the steps of:
5. selecting a new one of the set-aside audiences cards;
6. selecting a new messages card from a collection of messages cards each listing a potential message;
7. evaluating whether the message on the selected messages card is appropriate for communicating to the audience on the selected set-aside audiences card;
8. iterating over the steps F & G until each of the collection of messages cards have been selected; and
9. iterating over steps E, F, G, & H until each of the set-aside audiences cards have been selected;
C. selecting the communication channels to communicate the defined messages to the identified audiences including the steps of:
10. again selecting a new one of the set-aside audiences cards;
11. selecting a channels card from a collection of channels cards each listing potential communications channels;
12. evaluating whether the communications channel on the selected channels card is appropriate for the audience on the selected set-aside audiences card;
13. iterating over the steps 11 & 12 until each of the collection of channels cards have been selected; and
14. iterating over steps 10, 11, 12, & 13 until each of the set-aside audiences cards have been selected;
D. determining means of evaluating the results of the publicity plan including the steps of:
15. selecting a new one of the appropriate channels cards;
16. selecting a results card from a collection of results cards listing potential means of determining results;
17. evaluating whether the potential means of determining results on the selected results card would be effective for the selected appropriate channels card;
18. iterating over the steps 16 & 17 until each of the collection of channels cards have been selected; and
19. iterating over steps 15, 16, 17, & 18 until each of the appropriate channels cards have been selected;
E. brainstorming ideas about the publicity plan including the steps of:
20. selecting a new ideas card from a collection of ideas cards each listing terms for inspiring ideas;
21. perusing the ideas terms on the selected ideas card to brainstorm for ideas; and
22. iterating over the steps 20 & 21 until each of the collection of ideas cards have been selected; and
F. evaluating budgets for the publicity plan including the steps of:
23. selecting a new budgets card from a collection of budgets cards listing potential budgets for the publicity plan;
24. brainstorming publicity plans that fall within the listed budget on the selected budget plan; and
25. iterating over the steps 23 & 24 until each of the collection of budgets cards have been selected.

10. The process of claim 9 further comprising the step of documenting the results of the previous steps for aiding in the implementation of the publicity plan.

11. A process for developing and documenting a publicity plan comprising the steps of:
A. identifying one or more target audiences including the steps of:
1. selecting a new audiences card from a collection of audiences cards each listing a potential audience;
2. evaluating selected audiences card to determine if the listed audience on the selected audiences card is relevant or useful;
3. setting aside the selected audiences card if it was determined to be relevant or useful;
4. iterating over the steps 1, 2, & 3 until each of the collection of audiences cards have been selected;
B. defining appropriate messages to communicate to each of the identified audiences including the steps of:
5. selecting a new one of the set-aside audiences cards;
6. selecting a new messages card from a collection of messages cards each listing a potential message;
7. evaluating whether the message on the selected messages card is appropriate for communicating to the audience on the selected set-aside audiences card, and if appropriate, documenting the result;
8. iterating over the steps F & G until each of the collection of messages cards have been selected; and
9. iterating over steps E, F, G, & H until each of the set-aside audiences cards have been selected;
C. selecting the communication channels to communicate the defined messages to the identified audiences including the steps of:
10. again selecting a new one of the set-aside audiences cards;
11. selecting a channels card from a collection of channels cards each listing potential communications channels;
12. evaluating whether the communications channel on the selected channels card is appropriate for the audience on the selected set-aside audiences card, and if appropriate, documenting the result;
13. iterating over the steps 11 & 12 until each of the collection of channels cards have been selected; and
14. iterating over steps 10, 11, 12, & 13 until each of the set-aside audiences cards have been selected;
D. determining means of evaluating the results of the publicity plan including the steps of:
15. selecting a new one of the appropriate channels cards;
16. selecting a results card from a collection of results cards listing potential means of determining results;
17. evaluating whether the potential means of determining results on the selected results card would be effective for the selected appropriate channels card, and consider further activities to make measurements more effective and documenting the results;
18. iterating over the steps 16 & 17 until each of the collection of channels cards have been selected; and
19. iterating over steps 15, 16, 17, & 18 until each of the appropriate channels cards have been selected;
E. brainstorming ideas about the publicity plan including the steps of:
20. selecting a new ideas card from a collection of ideas cards each listing terms for inspiring ideas;
21. perusing the ideas terms on the selected ideas card to brainstorm for ideas and documenting the brainstormed ideas; and
22. iterating over the steps 20 & 21 until each of the collection of ideas cards have been selected; and
F. evaluating budgets for the publicity plan including the steps of:
23. selecting a new budgets card from a collection of budgets cards listing potential budgets for the publicity plan;
24. brainstorming publicity plans that fall within the listed budget on the selected budget plan and documenting the potential plans; and
25. iterating over the steps 23 & 24 until each of the collection of budgets cards have been selected.
